(19) United States
(12) Patent Application Publication
(10) Pub. No.: US 2012/0182624 A1
(43) Pub. Date: Jul. 19, 2012

(54) LENS AND PROCESSING METHOD OF THE SAME

(75) Inventors: Takeshi Itou, Hachioji-shi (JP); Takayuki Kamikura, Machida-shi (JP)

(73) Assignee: Konica Minolta Opto, Inc., Tokyo (JP)

(21) Appl. No.: 13/498,320

(22) PCT Filed: Aug. 24, 2010
(86) PCT No.: PCT/JP2010/064224

§ 371 Date: Mar. 26, 2012

(30) Foreign Application Priority Data
Sep. 29, 2009 (JP) 2009-224599

(51) Int. Cl. G02B 3/00; B23C 3/00

(52) U.S. Cl. 359/642; 409/131

(57) ABSTRACT

Disclosed is a lens wherein characteristic direction of aberration and the like can be easily determined, and a lens processing method. A reference point of the characteristic direction of aberration and the like is clarified by providing a thin portion (103) of a flange section (102) with a mark portion (106), and the characteristic direction of aberration and the like can be easily and accurately determined. Furthermore, by not removing the whole flange section (102) in the thickness direction, the center position of the lens is prevented from shifting at the time of attaching the lens (100), and the processing portion of the lens (100) can be prevented from hitting a case and the like at the time of transferring the lens (100).

### TECHNICAL FIELD

The present invention relates to a lens formed of resin, to be mounted on an optical pick-up device, and a processing method of the same.

### BACKGROUND ART

In order to prevent the central position of a lens from shifting, there is a lens in which a portion of its flange is removed as a stepping shape, while other portions in the thickness direction of the flange remain. (See Patent Document 1.)

### DOCUMENTS OF PRIOR ART

### Patent Document

Patent Document 1: Unexamined Japanese Patent Publication No. 2007-212744

### SUMMARY OF THE INVENTION

### Problems to be Solved by the Invention

Since lenses to be mounted on optical pick-up devices have predetermined aberrations and the like, it is necessary to determine not only the central positions of the lenses but also the characteristic direction of the aberration, and the like.

However, concerning lenses described in Patent Document 1, since the total shape of its removed portion is in straight, and a reference point (such as a point on which a gate portion exists) of the characteristic direction of the aberration and the like are not known, it may be difficult to simply determine the characteristic direction and to properly assemble the lens on a device.

Due to the above problem, an object of the present invention is to offer lenses in which the characteristic direction of the aberration and the like are easily determined, and to offer a processing method of said lenses.

### Means to Solve the Problem

In order to solve the above problem, a lens relating to the present invention includes:

an optical functional section including an optical surface; and

a flange section provided around the optical functional section,

wherein the flange section includes a thin portion which is one whose part in a thickness direction is removed from the flange section,
wherein the thin portion includes:

a first straight portion having a first cut surface which is nearly parallel to an optical axis;

a second straight portion having a second cut surface which is nearly parallel to the optical axis; and

a mark portion which is formed between the first straight portion and the second straight portion.

Since the mark portion is provided on the thin portion of the flange section of the lens, the reference point of the characteristic direction of the aberration and the like becomes clear, so that the characteristic direction of the aberration and the like can be determined simply and precisely. Further, since the flange section of the lens is not completely removed in the thickness direction, when the lens is assembled on the device, the central position of the lens is prevented from adversely shifting, and when the lens is transported, shaped sections of the lens are prevented from adversely hitting the transporting case.

Further, according to a specific embodiment, the first cut surface of the first straight line portion and the second cut surface of the second straight portion are arranged not to be parallel to each other, and the mark portion is formed on an intersecting line where the first cut surface and the second cut surface intersect. In this case, since the first and second cut surfaces are arranged not to be parallel, the intersecting line and its neighborhood are automatically determined to be a mark portion, so that the mark portion can be shaped easily, thereby the lenses are processed, receiving low adverse influence (such as pressure and heat) against the optical surface and the like, during the process.

Further, according to another embodiment, due to the intersection of the first and second cut surfaces, the mark portion exhibits a valley shape, hollowing in a radial direction, or exhibits a mountain shape, protruding in a radial direction. In this case, a mountain line or a valley line, each of which is formed on the intersecting section of the first and second cut surfaces, can be determined as a reference point of the characteristic direction of the aberration and the like, so that lenses, carrying a mark at high discrimination, can be processed.

According to still another embodiment, the first cut surface of the first straight portion and the second cut surface of the second straight portion are arranged parallel to each other, and the thickness of the mark portion differs from the thickness of the first straight portion and the thickness of the second straight portion. In this case, since the first cut surface and the second cut surface are arranged parallel to each other, and the mark portion is formed by the difference of the thickness, so that lenses are processed by a simple method.

According to still another embodiment, the mark portion exhibits a concave shape whose thickness is thinner than those of first and second straight portions, or the mark portion exhibits a convex shape whose thickness is thicker than those of a first and second straight portions. In this case, since a center of the concave shape or the convex shape is determined as a reference point of the characteristic direction of the aberration and the like, so that lenses, carrying a mark at high discrimination, can be processed.

According to still another embodiment, the mark portion is formed, corresponding to a position where a gate portion is formed during injection. In this case, a lens is formed, while carrying the mark portion corresponding to the gate portion. Further, a finishing work for a portion, from which the gate portion is cut off, is also conducted, a processing work is shortened, so that lenses are processed, receiving low adverse influence (such as pressure and heat) against the processing work.

According to still another embodiment, a border area which is between an upper surface of a flange section and a bottom surface of a thin portion, and first and second cut surfaces, is formed to be a round shape. In this case, since the border, which is between the surfaces of the flange section and the thin portion, and the first and second cut surfaces, is formed to be round, lenses are formed, while burrs are removed from the border.

One processing method relating to the present invention is a processing method of a lens to be conducted in such a way that,

an objective portion, which is formed as a part of a periphery of the lens, is cut off by a cutting tool, whereby a thin portion whose part in a thickness direction is removed is formed, wherein said processing method includes steps of:

forming a first straight portion which forms the thin portion and includes a first cut surface which is nearly parallel to an optical axis;

forming a second straight portion which forms the thin portion and includes a second cut surface which is nearly parallel to the optical axis; and

forming a mark portion which forms the thin portion between the first straight portion and the second straight portion.

According to the above detailed processing method of the lens, since the flange section is not completely removed in the thickness direction, areas to contact with the cutting tool become small, deterioration of the lens characteristics, which is due to compression stress during the removal work and thermal propagation, can be reduced. Further, another surface of the flange section, which has not been worked by the cutting tool, does not receive any adverse influence during the work. That is, said surface keeps its original shape, and is prevented from adverse influence during the measurement of the aberration and the like. Still further, since the flange section is not completely removed in the thickness direction, when the lens is assembled on the device, the central position of the lens is prevented from shifting, and when the lens is transported, shaped sections of the lens are prevented from adversely touching to the transporting case. Still further, the mark portion is provided on the thin portion of the flange section, it is possible to process lenses whose characteristic direction of the aberration and the like are simply and precisely determined.

Still further, concerning a practical embodiment of the present invention, the cutting tool represents an end mill. When the first and second straight portions are formed, the end mill is controlled to move in a straight line in the direction perpendicular to the optical axis, so that the lens of the present invention is created. In this case, overall processing work for forming the thin portion can be successively conducted together, which results in a simple processing method of the lenses.

### EXPLANATION OF THE DRAWINGS

FIG. 1(A) is a front view of a lens relating to Embodiment 1, FIG. 1(B) is a side view, viewed in direction A in FIG. 1(A), and FIG. 1(C) is a side view, viewed in direction B in FIG. 1(A).

FIG. 2 is a block diagram to explain a processing device.

FIGS. 3(A) and (B) are a plane view and a side view of a chucking device, respectively, provided on the processing device shown in FIG. 2.

FIGS. 4(A) and (B) are schematic drawings to explain the cutting process of the leas.

FIGS. 5(A)-(C) are a front view of a lens relating to Embodiment 2, a side view which is viewed in direction A in FIG. 5(A), and a side view which is viewed in direction B in FIG. 5(A), respectively.

FIGS. 6(A)-(C) are a front view of a lens relating to Embodiment 3, a side view which is viewed in direction A in FIG. 6(A), and a side view which is viewed in direction B in FIG. 6(A), respectively.

FIGS. 7(A)-(C) are a front view of a lens relating to Embodiment 4, a side view which is viewed in direction A in FIG. 7(A), and a side view which is viewed in direction B in FIG. 7(A), respectively.

FIGS. 8(A)-(C) are a front view of a lens relating to Embodiment 6, a side view which is viewed in direction A in FIG. 8(A), and a side view which is viewed in direction B in FIG. 8(A), respectively.

FIG. 9 is a side view of a lens relating to Embodiment 6.

### PREFERRED EMBODIMENTS OF THE INVENTION

### Embodiment 1

A lens and a lens processing method relating to Embodiment 1 will now be detailed, while referring to the drawings.

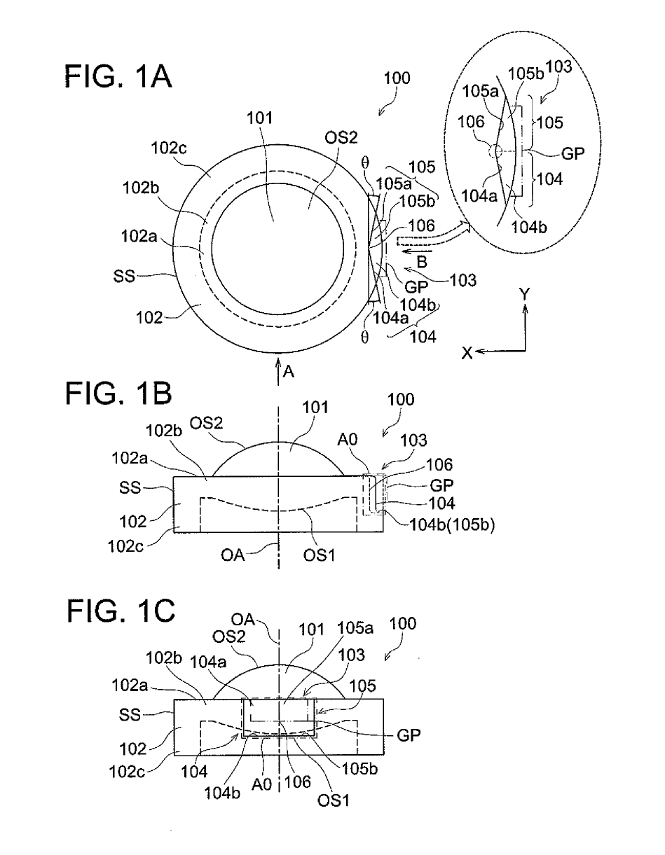

Lens 100, shown in FIGS. 1(A), 1(B) and 1(C), is formed of resin, and said lens represents a pick-up lens, being an objective lens to be used for an optical pick-up device, for example. Lens 100 includes main section 101 as an optical functional section having an optical function, and flange section 102 which exists on the periphery of main section 101. In FIG. 1(B), main section 101 has optical surface OS1, exhibiting a low curvature, at a lower surface (which faces the information recording media), and optical surface OS2, exhibiting great curvature, at an upper surface (which faces a laser light source).

Flange section 102 includes orbicular zone 102b having ring-shape surface 102a being a reference surface for assembling and measuring lens 100, and cylindrical supporting portion 102c protruding from orbicular zone 102b to one optical surface OS1 of main section 101. Ring-shape surface 102a of orbicular zone 102b extends perpendicular to optical axis OA, while supporting portion 102c extends parallel to optical axis OA. Supporting portion 102c, provided to support lens 100, protects optical surface OS2 during transportation and storage. Supporting portion 102c has thin portion 103 on the outside of a portion of supporting portion 102c, wherein said thin portion 103 is formed by finish machining after molding.

Thin portion 103 is formed in such a way that a specific area of supporting portion 102c is cut from its outside in optical axial direction OA. Thin portion 103, arranged on side surface SS of supporting portion 102c, is separated from main section 101 by a predetermined distance. Thin portion 103 is a step like a valley which is hollowed in optical axial direction OA and the radial direction. Thin portion 103 includes first straight portion 104, being formed like a distorted fan, viewed in a plane, second straight portion 105, being shaped like a distorted fan, viewed in a plane, and mark portion 106, positioned at the border of straight portions 104 and 105. Among thin portion 103, first straight portion 104 includes first cut surface 104a, which is nearly parallel to optical axis OA, and first bottom surface 104b, which is nearly perpendicular to optical axis OA. Second straight portion 105 includes second cut surface 105a, which is nearly parallel to optical axis OA, and second bottom surface 105b, which is nearly perpendicular to optical axis OA. As shown in FIG. 1(A), first straight portion 104 slants counterclockwise by small angle θ, against axis Y, while second straight portion 105 slants clockwise by small angle θ, against axis −Y. That is, first cut surface 104a and second cut surface 105a are not parallel to each other, to sandwich mark portion 106. That is, mark portion 106 extends in optical axial direction OA, between first straight portion 104 and second straight portion 105, and mark portion 106 exists on the intersecting line of first cut surface 104a and second cut surface 105a. As shown in FIG. 1(A), when optical surface OS2 is viewed from the top, parallel to optical axis OA, mark portion 106 is viewed as a valley like shape, which dips in the radial direction, due to the intersection of first and second cut surfaces 104a and 105a. As shown in FIG. 1(B), the border, which exists between ring-shape surface 102a, being the upper surface of flange section 102, and first and second cut surfaces 104a and 105a, is formed as a rounded surface. Further, the border, which exists between second bottom surfaces 104b and 105b, and first and second cut surfaces 104a and 105a, is formed as a rounded surface. At thin portion 103, mark portion 106 functions as a mark for showing a position where gate portion GP existed. That is, mark portion 106 is a reference point of the characteristic direction of the aberration and the like, which still remain in lens 100.

Before lens 100 is processed, gate portion GP has been formed on a portion of supporting portion 102c, which is the side of flange section 102. However after lens 100 is processed, thin portion is formed so that gate portion GP is removed. That is, in the present embodiment, before lens 100 is processed, gate portion GP and a portion (being processing area AO) of supporting portion 102c to form thin portion 103, are processing objects to be removed by a cutting or a resection process.

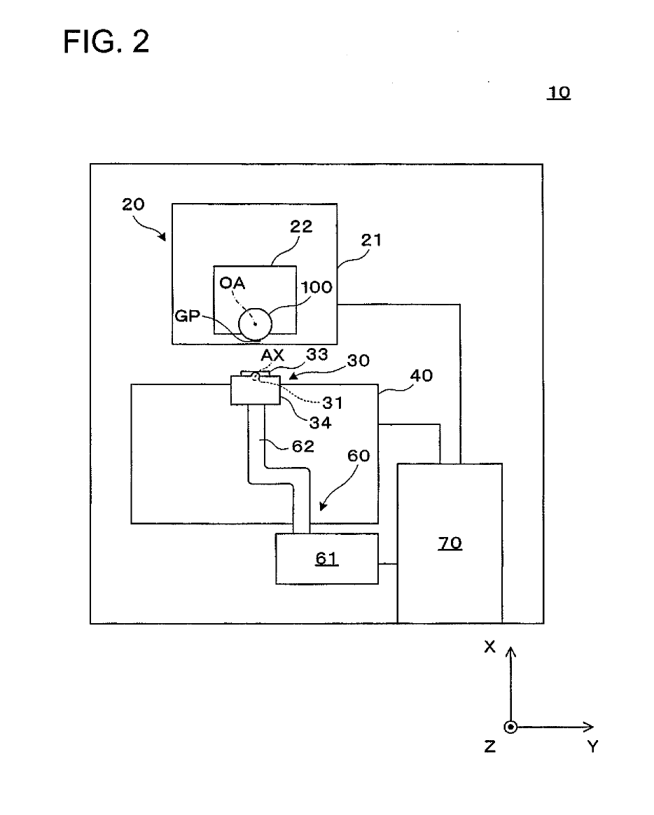

The processing method of lens 100, which is shown in FIG. 1(A), will now be detailed, while referring to FIG. 2.

FIG. 2 is a drawing to explain a processing device to be used, for processing lens 100. Processing device 10 is a device for removing gate portion GP from lens 100 as a processing object. Processing device 10 includes holder device 20, cutting unit 30, NC device 40, dust chamber 60, and control device 70.

Holder device 20, serving as a lens holder, includes supporting stage 21 and chucking device 22. Chucking device 22, serving as a lens supporting section, detachably clamps lens 100. Chucking device 22 supports the lower surface of lens 100, to hold lens 100 horizontally, and also supports gate portion GP, formed on a portion of the periphery of lens 100, to face cutting unit 30.

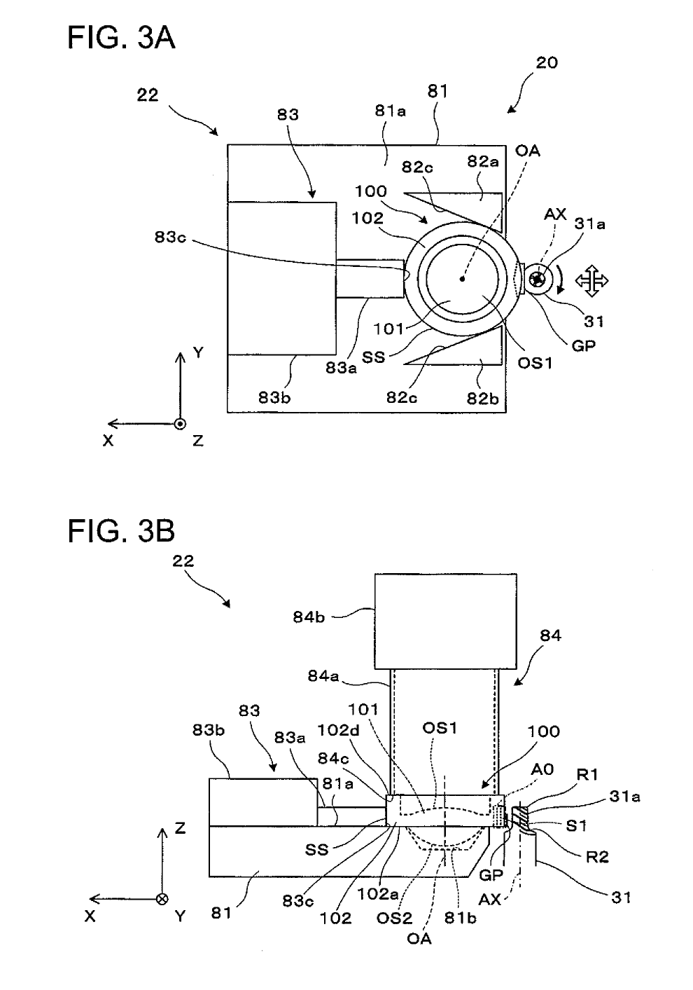

As shown in FIGS. 3(A) and 3(B), chucking device 22 includes supporting table 81, movement controlling members 82a and 82b, side surface chucking section 83, and upper surface chucking section 84. Supporting table 81 includes supporting surface 81a, and concave section 81b. Supporting surface 81a is a flat surface to support lens 100 horizontally, while also supporting ring shape surface 102a of flange section 102. Concave section 81b, which accommodates a protruding portion of main section 101 of lens 100, is provided at the end of supporting table 81, so that concave section 81b is a hollow of supporting surface 81a. Lens 100 is arranged in such a way that the upper side of main section 101, being optical surface OS2 facing the laser light source, faces supporting table 81. Due to this, the depth of concave section 81b is greater than the protruding amount of optical surface OS2. That is, concave section 81b is formed to accommodate lens 100, while optical surface OS2 is prevented from touching the inner surface of concave section 81b. Due to this structure, when lens 100 is processed, concave section 81b protects optical surface OS2 of main section 101 of lens 100. When lens 100 is clamped in holder device 100, gate portion GP and processing area AO are arranged to protrude toward the front side of supporting table 81, whereby cutting unit 30 is prevented from cutting them.

Paired movement controlling members 82a and 82b are arranged at the top of supporting table 81, being (−X) side. Movement controlling members 82a and 82b are triangle members, whose side surfaces 82c and 82c are perpendicular to supporting surface 81a. Since side surfaces 82c and 82c are in contact with side surface SS of supporting section 102c, lens 100 is controlled not to move in direction −X. Side surface chucking section 83 is arranged on the rear on supporting table 81, behind paired movement controlling members 82a and 82b. Side surface chucking section 83 includes pushing rod 83a which is controlled to move toward side surface SS of lens 100, and rod driving section 83b which controls pushing rod 83a to move back and forth. When pushing rod 83a is moved forth, end surface 83c comes into contact with side surface SS of lens 100, by an appropriate pressure. Due to this operation, paired movement controlling members 82a and 82b and pushing rod 83a can clamp lens 100 on supporting table 81 in an alignment condition. Just before lens 100 is clamped, if lens 100 is rotated at a small angle on supporting table 81, gate portion GP can be adjusted to accurately face the front, which is in direction −X, based on optical axis OA.

Top surface chucking section 84 is provided above supporting table 81. Top surface chucking section 84 includes cylinder section 84a which can be moved toward lower surface 102d of flange section 102, and cylinder driving section 84b which controls cylinder section 84a to move. Top surface 84c of cylinder section 84a is moved to gently come into contact with lower surface 102d of flange section 102 of lens 100, so that lower surface 102d of flange section 102 is pushed downward by an appropriate pressure. Due to this operation, lens 100 is sandwiched between supporting table 100 and cylinder member 84a, whereby lens 100 can be clamped in a stable condition. By these clamping operations, when lens 100 is processed by end mill 31, lens 100 is prevented from rotating. Further, cylindrical member 84a has a function to protect optical surface OS1 of main section 101 of lens 100, during the cutting operation.

Returning to FIG. 2, cutting unit 30 includes end mill 31, rotation driving section 33, and dust cover 34, each of which functions as a processing section. Among various devices of cutting unit 30, end mill 31 is a cutting device which rotates around shaft AX which is parallel to axis Z, to mechanically remove gate portion GP and the like, which are incidentally formed on lens 100. In this case, as shown in FIGS. 3(A), 3(B) and 3(C), not only gate portion GP, but also processing area AO, which corresponds to an inversion of processed thin portion 103 and is a portion of supporting portion 102c of flange section 102, are removed as processing objects.

The side of gate portion GP is cut by end portion 31a of end mill 31, whereby cut surface S1 is formed as a cut worked surface.

In detail, cut surface S1 represents a surface which includes first and second cut surfaces 104a and 105a, and first and second bottom surfaces 104b and 105b.

Further, as shown in FIG. 3(B), cutting edge R1 of end portion 31a and elementary part R2 of end mill 31 are formed to be curved surfaces.

Due to end mill 31, as shown in FIG. 1(A), curved surface shapes, exhibiting a desired curvature, can be formed at the borders between ring-shape surface 102a of flange section 102, and first and second cut surfaces 104a and 105a corresponding to the same ring-shape surface.

Further, curved surfaces, exhibiting a desired curvature, can be formed at the borders between first and second bottom surfaces 104b and 105b, and first and second cut surfaces 104a and 105a corresponding to the same bottom surfaces.

Still further, since end portion 31a of end mill 31 is formed as the curved surface, abrasion due to the work is reduced, so that duration of end portion 31a can be prolonged.

Rotation driving section 33 shown in FIG. 2 allows end mill 31 to rotate at a high speed around shaft AX being parallel to optical axis OA of lens 100. Dust cover 34 is fixed on a frame member (which is not illustrated) to support rotation driving section 33.

Dust cover 34 totally covers end mill 31, so that dust is prevented from flying out of cutting areas, though the cutting edge of end mill 31 is partially exposed outside.

NC device 40 is a position driving device which supports cutting unit 30 and moves it in three dimensions.

In this case, against holder device 20, cutting unit 30 is driven in a straight line in a vertical direction against optical axis OA (that is, directions slanting ±θ degrees against directions ±Y), so that it is possible to cut off gate portion GP and processing area AO of lens 100, corresponding to the rotating excursion and the moving excursion of end mill 31.

Dust chamber 60 includes suction device 61 and suction duct 62. Suction device 61 includes an air ejection fan and an air filter. Suction duct 62 is extended from suction device 61, so that another end can be connected to the rear of dust cover 34 provided in cutting unit 30. Suction duct 62 vacuums the dusts generated around end mill 31 in dust cover 34, and sends the dusts to suction device 61.

Control device 70 controls the total operations of processing device 10, so that control device 70 controls the supporting operation of lens 100, conducted by holder device 20, the cutting operation of lens 100, conducted by cutting unit 30 and NC device 40, and the dust collecting operation, conducted by dust chamber 60.

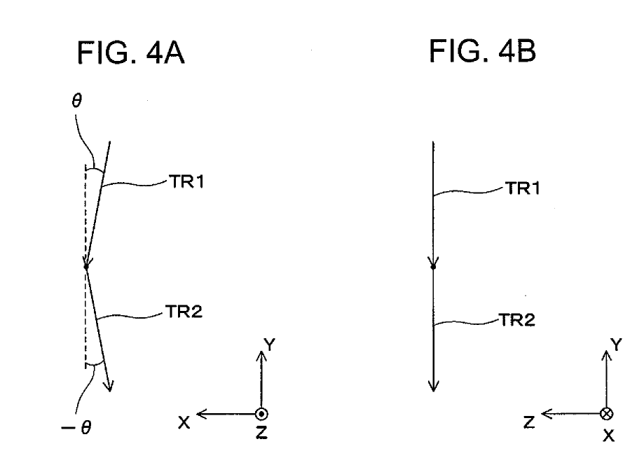

FIGS. 4(A) and 4(B) are schematic drawings to explain the cutting procedures of lens 100. End mill 31, shown in FIG. 2, rotates around shaft AX at a high speed, and moves at a predetermined speed in direction ±θ against direction −Y. In detail, first straight section 104, shown in FIG. 1(A), is formed on excursion TR1, while second straight section 105, shown in FIG. 1(A), is formed on excursion TR2. In this case, removed are processing area AO and gate portion GP existing on the outside of side surface SS of flange section 102. As shown in FIG. 4(A), when the excursion of end mill 31 is viewed in direction Z, concerning excursions TR1 and TR2, their excursion directions change from direction +θ to direction −θ, based on direction −Y, from a position corresponding to mark portion 106 shown in FIG. 1(A). Further, as shown in FIG. 4(B), when, the excursion of end mill 31 is viewed in direction X, excursions TR1 and TR2 are viewed as straight lines extending in direction −Y. As a result, cut surface S1, that is, cut surfaces 104a and 105a are formed as a cut remain or the cut worked surface.

As detailed above, according to the lens processing method of the present embodiment, flange section 102 is not cut off perfectly in its thickness direction, so that the area contacting with end portion 31a of end mill 31 is effectively reduced. Further, end portion 31a of end mill 31 comes into contact with flange section 102 in a direction parallel to optical axial direction OA, so that pressing force against local portions and abnormal heat are prevented. Accordingly, deterioration of lens performance, due to the compression stress and heat propagation during the process, is effectively reduced. Still further, since the surface of flange section 102, which is not processed, is not influenced by processing, the molded condition is kept, whereby the characteristics of the aberration and the like are prevented from receiving adverse influence. Still further, the borders between ring-shape surface 102a of flange section 102, and first and second cut surfaces 104a and 105a corresponding to the same ring-shape surface, and the borders between first and second bottom surfaces 104b and 105b, and first and second cut surfaces 104a and 105a corresponding to the same bottom surfaces are formed to be curved surface shapes, so that these bothers are prevented from creating burrs. Still further, since flange section 102 is not cut off perfectly in its thickness direction, when lens 100 is assembled, the center position of lens 100 is prevented from shifting, and when lenses 100 are transported, shaped sections of the lens are prevented from contacting the transporting case.

Still further, concerning lens 100 which is processed by the above described processing method, since mark portion 106 is formed on thin portion 103 of flange section 102, the reference point of the characteristic direction of the aberration and the like is clearly defined, so that the characteristic point of the aberration and the like can be determined easily and precisely. Further, since the external force, due to processing of the lens and the influence due to heat, can be kept to a minimum, so that the lens characteristics can be kept at a high level in case of a high NA lens and the like.

### Embodiment 2

A lens relating to Embodiment 2 will now be detailed. The lens relating to Embodiment 2 is modified from lens 100 of Embodiment 1. Various features, which are not detailed in Embodiment 2, are the same as those in Embodiment 1, so that redundant explanations are omitted.

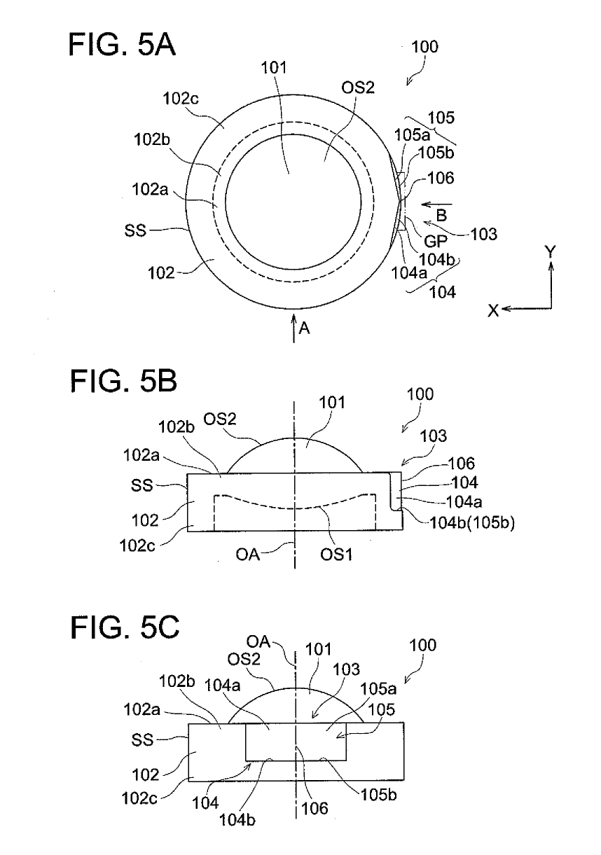

As shown in FIGS. 5(A), 5(B) and 5(C), thin portion 103 formed on lens 100 of Embodiment 2 includes a step sinking in optical axial direction OA, which is the same structure as that of Embodiment 1. However, the center of thin portion 103 is raised, being externally protruded in the radial direction, which differs from Embodiment 1. In this case, first straight portion 104 and second straight portion 105 are symmetrically arranged about raised mark portion 106 which prolongs in the direction of optical axis OA. Further, first bottom surface 104b of first straight portion 104 is arched, and first bottom surface 105b of second straight portion 105 is also arched.

In the present embodiment, mark portion 106 can be clearly defined so that the characteristic direction of the aberration and the like can be determined easily and accurately.

### Embodiment 3

A lens relating to Embodiment 3 will now be detailed. The lens relating to Embodiment 3 is modified from lens 100 of Embodiment 1. Various features, which are not detailed in Embodiment 3, are the same as those in Embodiment 1, so that any redundant explanation is omitted.

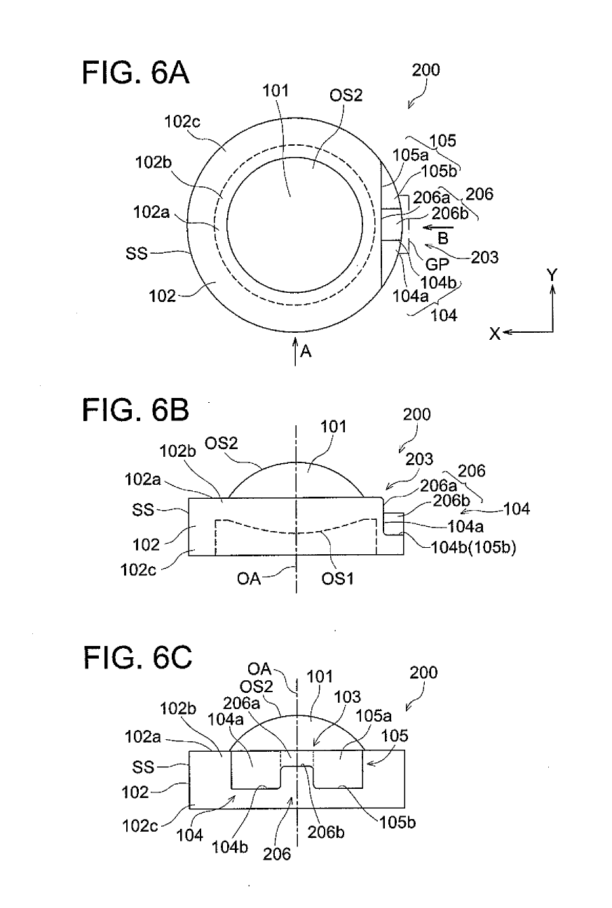

As shown in FIGS. 6(A), 6(B), and 6(C), thin portion 203 formed on lens 200 of Embodiment 3 includes a step sinking in optical axial direction OA, which is the same structure as that of Embodiment 1. However, convex mark portion 206 is formed on the center of thin portion 203, which differs from Embodiment 1. Mark portion 206, being a rectangle in the flat view, is arranged between first straight portion 104 and second straight portion 105. Mark portion 206 includes third cut surface 206a, being nearly parallel to optical axis OA, and third bottom surface 206b, being nearly perpendicular to optical axis OA.

### Embodiment 4

A lens relating to Embodiment 4 will now be detailed. The lens relating to Embodiment 4 is modified from lens 200 of Embodiment 3. Various features, which are not detailed in Embodiment 4, are the same as those in Embodiment 3, so that any redundant explanation is omitted.

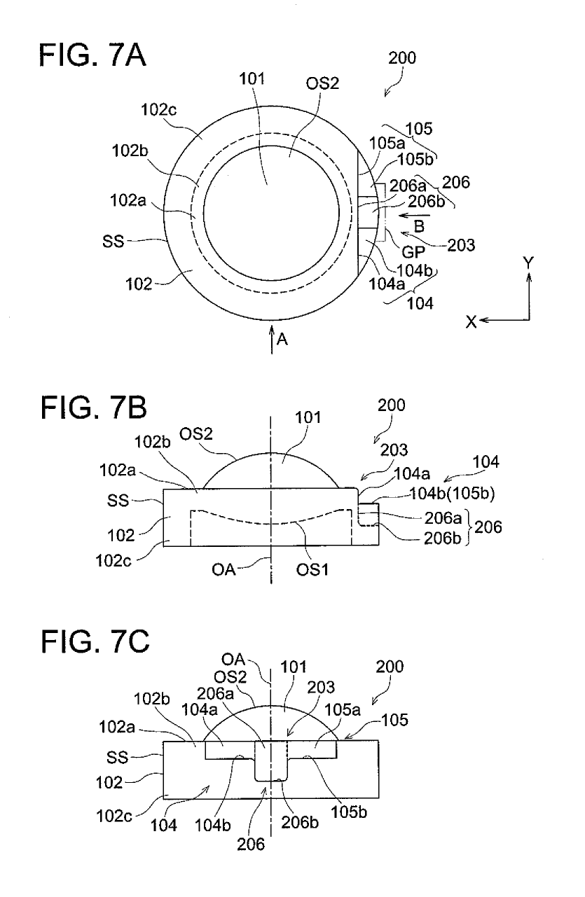

As shown in FIGS. 7(A), 7(B), and 7(C), thin portion 203 formed on lens 200 of Embodiment 4 includes a step sinking in optical axial direction OA, which is the same structure as that of Embodiment 3. However, concave mark portion 206 is formed on the center of thin portion 203, which differs from Embodiment 3. Mark portion 206, being a rectangle in the flat view, is arranged between first straight portion 104 and second straight portion 105. Mark portion 206 includes third cut surface 206a, being nearly parallel to optical axis OA, and third bottom surface 206b, being nearly perpendicular to optical axis OA.

### Embodiment 5

A lens relating to Embodiment 5 will now be detailed. The lens relating to Embodiment 5 is modified from lens 200 of Embodiment 3. Various features, which are not detailed in Embodiment 5, are the same as those in Embodiment 3, so that any redundant explanation is omitted.

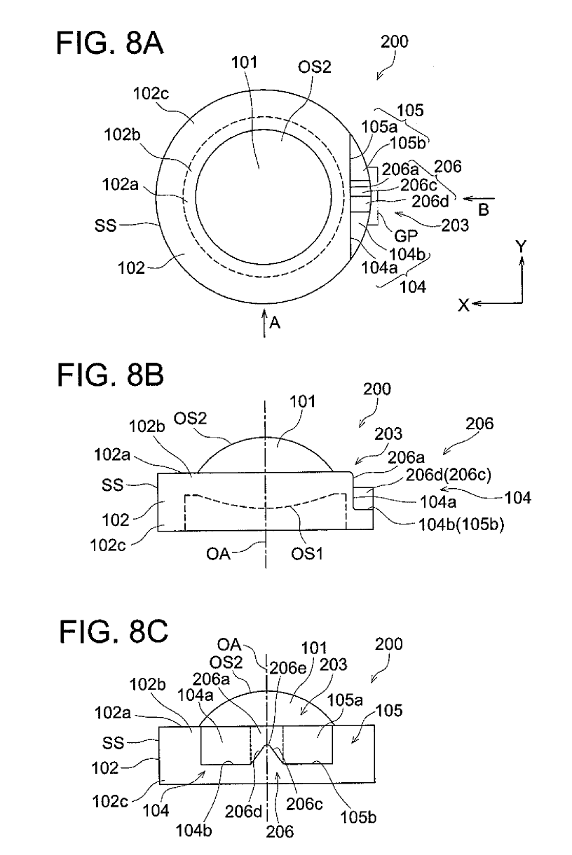

As shown in FIGS. 8(A), 8(B), and 8(C), thin portion 203 formed on lens 200 of Embodiment 5 includes a step sinking in optical axial direction OA, which is the same structure as that of Embodiment 3. However, raised mark portion 206 is formed on the center of thin portion 203, which differs from Embodiment 3. Mark portion 206, being a rectangle in the flat view, is arranged between first straight portion 104 and second straight portion 105. Mark portion 206 includes third cut surface 206a, being nearly parallel to optical axis OA, and paired bottom surfaces 206c and 206d, being slanted against optical axis OA. Further, at the border of bottom surface 206c and 206d, ridge line 206e is formed, so that the center of mark portion 206 can be clearly viewed. Still further, inclinations of bottom surfaces 206c and 206d can be changed, so that mark portion 206 can be formed to be concave.

### Embodiment 6

A lens relating to Embodiment 6 will now be detailed. The lens relating to Embodiment 6 is modified from lens 100 of Embodiment 1. Various features, which are not detailed in Embodiment 6, are the same as those in Embodiment 1, so that any redundant explanation is omitted.

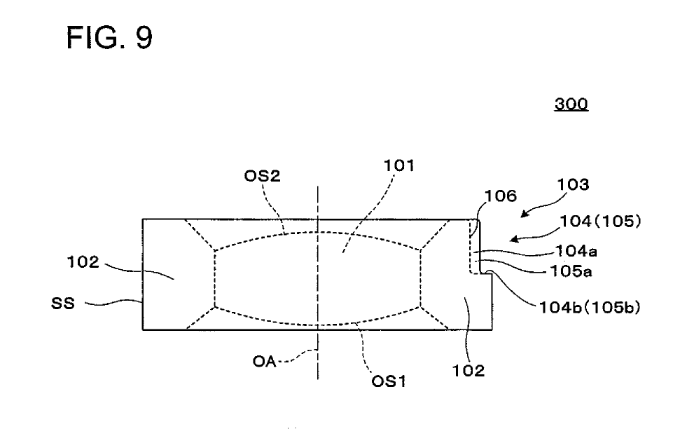

As shown in FIG. 9, lens 300 relating to Embodiment 6 includes optical surfaces OS1 and OS2, whose curvatures are nearly the same to each other. Thin portion 103 is formed to be the same as Embodiment 1, but thin portion 103 can be changed like Embodiment 2, or thin portion 103 can be changed similar to those of Embodiments 3-5. Concerning lens 300 shown in Embodiment 6, mark portion 106 or the like can be clearly defined, so that the characteristic direction of the aberration and the like can be determined easily and precisely. Further, in the case of lens 300 of the present embodiment, the front and the rear of lens 300 can be determined easily, based on whether thin portion 103 is viewed directly or not.

The present invention has been detailed, while various embodiments have been introduced. The present invention is not limited to the above detailed embodiments, and various variations are allowed.

For example, end mill 31, being a single end mill, is used for the processing, however, plural end mills can be used for removing gate portions GP of lens 100, 200 and 300.

Concerning the above detailed embodiment, after lens 100 is fixed, while optical surface OS2 faces supporting table 81, end mill 31 moves from direction −Z to direction +Z, whereby a lower portion, being (−Z) side, of supporting portion 102c is partially cut off as processing area AO, however, the present invention is not limited to this processing method. For example, it is possible to work in such a way that after lens 100 is fixed, while optical surface OS1 faces supporting table 81, end mill 31 moves from direction +Z to direction −Z, whereby an upper portion, being the +Z side, of supporting portion 102c is partially cut off as processing area AO.

In the above embodiments, detailed are gate portions GP of lens 100, 200 and 300 being removed, however, when unnecessary convex portions formed on lens 100, 200 and 300 are removed, above detailed processing device 10 can be used.

In the above embodiment, end mill 31 is used as a cutting device. Instead of end mill 31, when a grind stone, serving as a grinding device, is used to remove gate portion GP or the like, mark portions 106 and 206 can also be clearly defined, whereby the characteristic direction of the aberration and the like, of lenses 100, 200 and 300 can be determined easily and precisely.

### EXPLANATION OF ALFA-NUMERICAL DESIGNATIONS

10 processing device
20 holder device
22 chucking unit
30 cutting unit
31 end mill
33 rotation driving section
34 dust cover
40 NC device
60 dust chamber
61 suction device
62 suction duct
70 control device
81 supporting table
82a and 82b movement controlling member
84 upper surface chucking section
AO processing area
A1 cutting area
AX shaft
100, 200 and 300 lens
101 main section
102 flange section
103 and 203 thin portion
104 and 105 straight portion
106 and 206 mark portion
GP gate portion
OA optical axis
OS1 and OS2 optical surface
S1 cut surface

1. A lens comprising:
an optical functional section including an optical surface; and
a flange section provided around the optical functional section,
wherein the flange section includes a thin portion which is one whose part in a thickness direction is removed from the flange section,
wherein the thin portion includes:
a first straight portion having a first cut surface which is nearly parallel to an optical axis;
a second straight portion having a second cut surface which is nearly parallel to the optical axis; and
a mark portion which is formed between the first straight portion and the second straight portion.

2. The lens of claim 1, wherein the first cut surface of the first straight section and the second cut surface of the second straight section are arranged not parallel to each other, and the mark portion is formed on an intersecting line where the first cut surface and the second cut surface intersect with each other.

3. The lens of claim 2, wherein due to the intersection of the first and second cut surfaces, the mark portion is formed to be a valley shape, hollowing in a radial direction, or exhibits a mountain shape, protruding in a radial direction.

4. The lens of claim 1, wherein the first cut surface of the first straight portion and the second cut surface of the second straight portion are arranged parallel to each other, and the thickness of the mark portion differs from the thickness of the first straight portion and the thickness of the second straight portion.

5. The lens of claim 4, wherein the mark portion exhibits a concave shape whose thickness is thinner than that of the first and second straight portions, or the mark portion exhibits a convex shape whose thickness is thicker than those of the first and second straight portions.

6. The lens of claim 1, wherein the mark portion is formed, corresponding to a position where a gate portion is formed during an injection molding work.

7. The lens of claim 1, wherein a border area which is between (1) an upper surface of the flange section and a bottom surface of the thin portion, and (2) the first cut surface and the second cut surface, is formed to be a round shape.

8. A processing method of a lens to be conducted in such a way that, an objective portion, which is formed as a part of a periphery of a lens, is cut off by a cutting tool, whereby a thin portion whose part in a thickness direction is removed is formed, wherein said processing method includes steps of:
forming a first straight portion which forms the thin portion and includes a first cut surface which is nearly parallel to an optical axis;
forming a second straight portion which forms the thin portion and includes a second cut surface which is nearly parallel to the optical axis; and
forming a mark portion which forms the thin portion between the first straight portion and the second straight portion.

9. The processing method of claim 8, wherein the cutting tool comprises an end mill, and when the first and second straight portions are formed, the end mill is controlled to move straightly in a direction perpendicular to the optical axis.
